(19) United States
(12) Patent Application Publication
(10) Pub. No.: US 2011/0015965 A1
(43) Pub. Date: Jan. 20, 2011

(54) Products having a scent name selected by consumers

(75) Inventors: George Kavin Morgan, III, Hamilton, OH (US); Robert Edward Reinerman, Cincinnati, OH (US); Laura Davenport Rollins, Cambridge, MA (US); Kaitlin McCartney Strovink, Bedford, MA (US); Amy Clymer Snelling, Needham, MA (US); Joseph Talmadge Morris, Melrose, MA (US); Meghan Marie Finnerty, Quincy, MA (US); Sheri Lee Kaufmann, Brookline, MA (US)

Correspondence Address: THE PROCTER & GAMBLE COMPANY;Global Legal Department - IP, Sycamore Building - 4th Floor, 299 East Sixth Street, CINCINNATI, OH, 45202, US

(73) Assignee: The Procter & Gamble Company, Cincinnati, OH (US)

(21) Appl. No.: 12/502,245

(22) Filed: Jul. 14, 2009

(51) Int. Cl. G06Q 10/00; G06Q 50/00; G06F 3/048; G06F 17/50

(52) U.S. Cl. 705/10; 705/12; 715/738; 700/97

(57) ABSTRACT

A method of providing an Internet Web site to obtain consumer's feedback to scents is an effective way to making consumer products.

### FIELD OF THE INVENTION

The present invention is directed to soliciting input from consumers in designing scents for consumer products.

### BACKGROUND OF THE INVENTION

Methods for recommending a fabric care product to a consumer via an Internet Web site based on a consumer's preference to a perfume has been described. See e.g., U.S. Pat. No. 7,099,856. However, such methods typically direct a consumer to existing products and are not necessarily used to design or name perfume scent for new products. There is a need to more fully engage consumers by tapping into their collective creativity, engaging consumers on a deeper emotional level, and/or obtaining better feedback in what consumer's want in their scent experience in using consumer products. See also US 2004/0107053 A1.

### SUMMARY OF THE INVENTION

The present invention attempts to address these and other needs by providing a method of making a consumer product having a perfume scent name comprising the steps: optionally providing an Internet Web page that invites the consumer to participate in designing the scent name to the consumer product; providing an Internet Web page to the consumer that provides at least two categories of sub-scents, wherein each of the at least two categories has a plurality of sub-scent names selectable by the consumer; obtaining the consumer's selection to the plurality of sub-scents for each category to generate consumer sub-scent selection data; using the consumer sub-scent selection data to design the perfume scent name of the consumer product; and manufacturing the consumer product having the designed perfume scent name. Products made by the aforementioned process are also provided.

### DETAILED DESCRIPTION OF THE INVENTION

Many perfumers will agree that a scent that a consumer perceives while laundering laundry and wearing laundered clothing is complex and will change from activity (e.g., opening the cap to a laundry detergent or opening the dryer door after laundry has been drying), over time (e.g., wearing clothing out of the dryer or wearing clothing that has been a closest for weeks), environmental conditions (e.g., such as heat from a clothing dryer to volatize perfume, sweat to release perfume encapsulated in moisture activated perfume systems), and other factors. A particular scent that a consumer perceives (through olfactory senses) at any moment in time is a result of volatized perfume ingredients). In turn, perfume is comprised of perfume ingredients. These perfume ingredients can be divided into two or more categories of so called “notes” based upon each perfume ingredient's volatility. Each perfume ingredient may have characteristic sub-scent described by a sub-scent name.

It is the collection of perfume ingredients and their respective sub-scents that provides a consumer with an overall scent experience (from using consumer product). The overall perfume and perfume scent can be named by a perfume scent name. For example, “APRIL FRESH” is an example of a perfume scent name used for the fabric softener sold under the brand name DOWNY. The perfume scent name can also be tied to an emotion or an emotion name.

Perfume ingredients, and their characteristic respective sub-scents, can be organized into categories (category members having a coming attribute) such as a top note, a middle note, and a base note. Top notes are perfume ingredients that are the most volatile (or other such attribute). These top notes are typically perceived first by a consumer; for example, when a dryer door is opened to retrieve drying laundry and hot air from the dryer volatizes these top notes. Generally high notes are typically described as having sub-scent names such as “citrus” or “fruity.” Low notes or base notes have the lowest volatility relative to the top notes and middle notes. Generally low notes or base notes are described by sub-scent names “woody” or “musky.” Middle notes have volatility between base notes and top notes. Generally middle notes are described by sub-scent name “floral.”

One way to measure a perfume ingredient's volatility is by the perfume ingredient's boiling point such as is described in U.S. Pat. No. 7,524,809, column 4, lines 38-61 (and references cited therein). Low volatile perfume ingredients (so called “enduring perfume ingredients”) are generally described in U.S. Pat. No. 7,524,809, column 4, lines 19-37; and high volatile perfume ingredients (so called “blooming perfume ingredients”) are generally described in US 2005/0192207 A1 (paragraphs 27 and 29).

Perfume is the overall chemical composition in the consumer product that imparts a desired perfume scent to the consumer. Perfume scent is the scent that is perceivable by the consumer when using a consumer product comprising perfume, or an article (e.g., laundry) having been treated by the consumer product (e.g., fabric care product). A perfume scent name is the name that describes the overall perfume and the perfume scent in the consumer product (e.g., APRIL FRESH). In turn, a perfume is often comprised of multiple perfume ingredients. Perfume ingredients impart a desired sub-scent to the consumer (the sub-scents collectively provide the overall perfume scent). The sub-scent from a perfume ingredient may be detectable by the consumer when the perfume ingredient is volatized and thus become detectable by the consumer's olfactory senses. A perfume ingredient's volatility depends upon the perfume ingredient's boiling point. A sub-scent name is the name that described the perfume ingredient and the resulting sub-scent.

One aspect of the invention provides a consumer product having a perfume scent name. In one embodiment, the consumer product is a fabric care product. Fabric care products include those products that are used in the treatment of laundry. Non-limiting examples include: liquid laundry detergent; dry laundry detergent (e.g., powder); liquid fabric softener (e.g., rinse-added); dryer sheets; dryer bars; wrinkle release sprays; fabric refresher sprays; laundry stain treatment sprays, pens, sticks, etc; and the like. Examples of brands names for fabric care products include TIDE, DOWNY, SWASH, and BOUNCE. In one embodiment, the described methods can be applied to any consumer product.

As can be appreciated by the previous discussion, scent from laundered laundry, scent from using fabric care products, and scent from fabric care products themselves can be complex. However, Applicant has developed a surprising simple method of engaging consumers to obtain consumer's feedback to scent to help make consumer products based (at least in part) on this consumer feedback.

One aspect of the invention provides having at least two, alternatively three, alternatively four, or more, categories of perfume ingredients and their sub-scents. These categories may be organized by a perfume ingredient's volatility (or other attribute). In one embodiment, the categories are designated as “top notes,” middle notes,” and “base notes” It is appreciated that the terms “top note” or even “note” need not be used but rather that a scent is categorized into at least two categories, alternatively three categories, alternatively four or more categories, based on an attribute (wherein preferably the attribute is volatility or boiling point) of the perfume ingredients organized in the respective category.

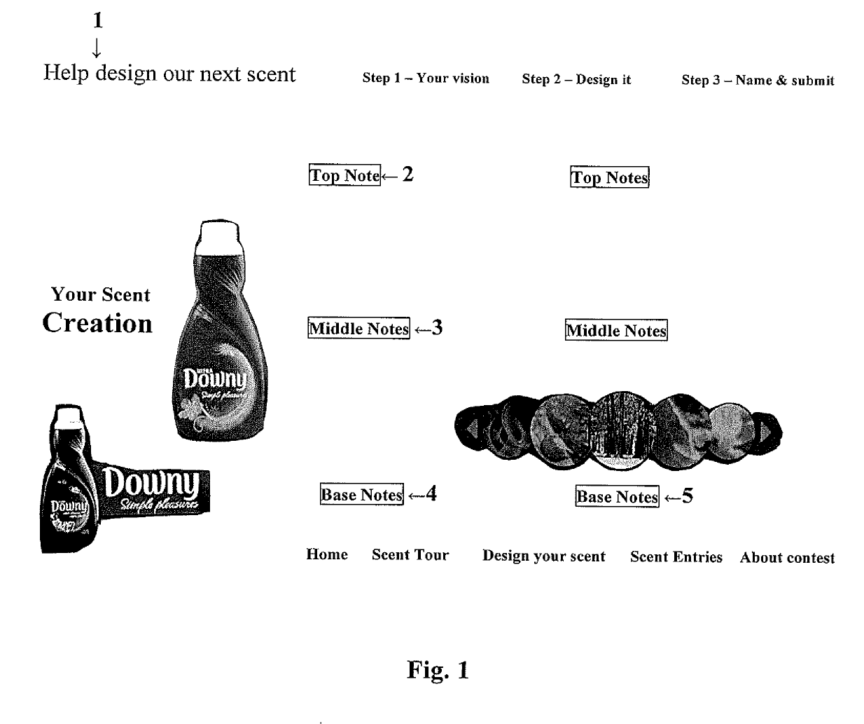

One aspect of the invention provides for an Internet Web page that invites the consumer to participate in designing the scent name for the consumer product. FIG. 1 is an example of an Internet Web page that provides such an invitation. The Web page asks the consumer to “Help Design Our Next Scent” (1).

Another aspect of the invention provides for an Internet Web page to the consumer that provides at least two categories (alternatively at least three or more categories) of sub-scents, wherein each of the at least two categories has a plurality of sub-scent names selectable by the consumer. FIG. 1 is an example of such a Web page. The perfume scent is divided into three categories namely “Top Notes” (2), “Middle Notes” (3), and “Base Notes” (4). Each of the three notes (2, 3, 4) has a plurality of sub-scents or sub-scent names that the consumer may select. In FIG. 1, Base Notes (4) has been selected with the consumer being offered a plurality of sub-scent names in the Base Note category (5) to select. These sub-scent names (5) may be presented to the consumer with names such as “woodsy” or simply a picture of woods or a combination thereof. For purposes of clarification, the term “sub-scent name” is inclusive of names, pictures, drawings, symbols, and the like, or combinations thereof that describe the sub-scent. Although not shown in FIG. 1, a plurality of Middle Note sub-scent names and a plurality of Top Note sub-scent names are provided to the consumer. Non-limiting examples of Base Note sub-scent names may include woody, musky, & sweet (vanilla). Non-limiting examples of Middle Note sub-scent names may include floral, herbal, & minty. Non-limiting examples of Top Note sub-scent names may include fruity, citrus, & green.

Another aspect of the invention provides obtaining the consumer's selection to the plurality of sub-scents for each category to generate consumer sub-scent selection data. Data collection from the Internet (and storage thereof) is well known in the art. In one embodiment, the consumer sub-scent selection data is statistically analyzed.

The term “statistically analyzed” is used in the broadest sense to include simple actions such a tabulating the results, providing mean, medium, and mode, or more complex calculations such as mathematically modeling. In turn, “mathematically modeling” means broadly those techniques known in the art to generate a mathematical model built upon the input of variables (i.e., dependent and independent), wherein the model is capable of forecasting or predicting events, preferably within art-accepted ranges of error. Statistical techniques may include regression; pooled regression; ordinary least squares (OLS) regression; mixed modeling; multivariate regression modeling; and the like. Other sources of data for inclusion into the statically analysis step may include consumer purchase data (U.S. Pat. No. 5,490,060) or consumer demographic data. The forecasted or predicted results may include determining those products that will be the most successful in the market place or with a specific consumer segment.

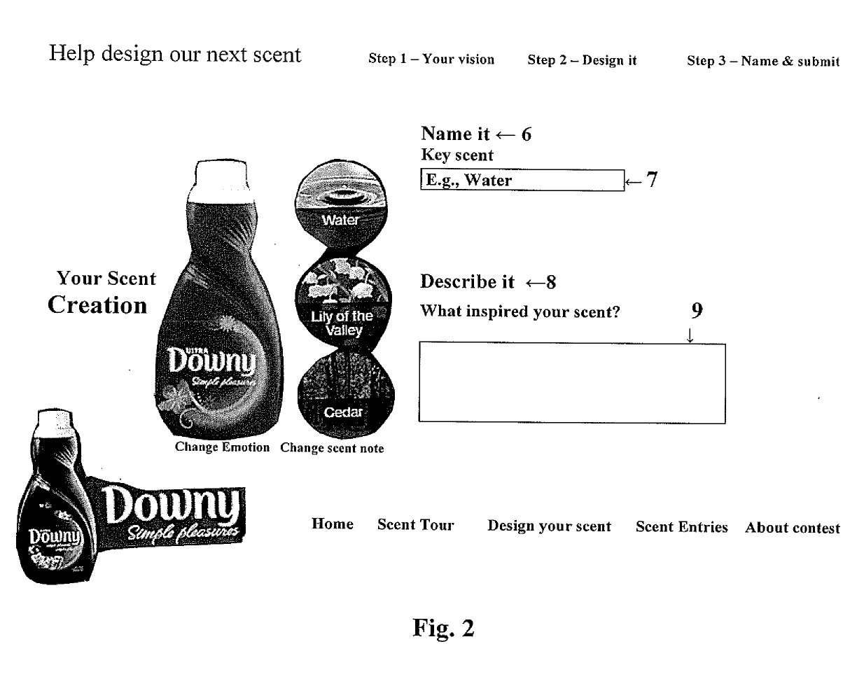

Another aspect of the invention provides the step of providing an Internet Web page that invites the consumer to provide the scent name to the consumer product; and obtaining the consumer's response to naming of the scent as consumer scent naming data. FIG. 2 is an example of an Internet Web page that asks the consumer to name the overall perfume scent by stating “Name It” (6). The Web page obtains the consumer's response by providing a space for the consumer to type the name of the perfume scent (7). These perfume scent names (e.g., text) obtained from consumers is an example of consumer scent naming data. Data collection from the Internet (and storage thereof) is well known in the art. In turn, the consumer scent naming data may, in some embodiments, be statistically analyzed. The term “statistically analyzed” is previously defined.

Another aspect of the invention provides for the step of providing an Internet Web page that invites the consumer to name an emotion to the scent name the consumer provides; and to obtain the consumer's response to naming of the emotion as consumer emotion naming data. The Web page of FIG. 2 invites the consumer to describe the scent i.e., “Describe It” (8). The Web page obtains the consumer's response to naming of the emotion, “What Inspired Your Scent,” by providing a box that the consumer may type into (9). Text received from the consumer is an example of consumer emotion naming data. Data collection from the Internet (and storage thereof) is well known in the art. In turn, the consumer emotion naming data may, in some embodiments, be statistically analyzed. The term “statistically analyzed” is previously defined.

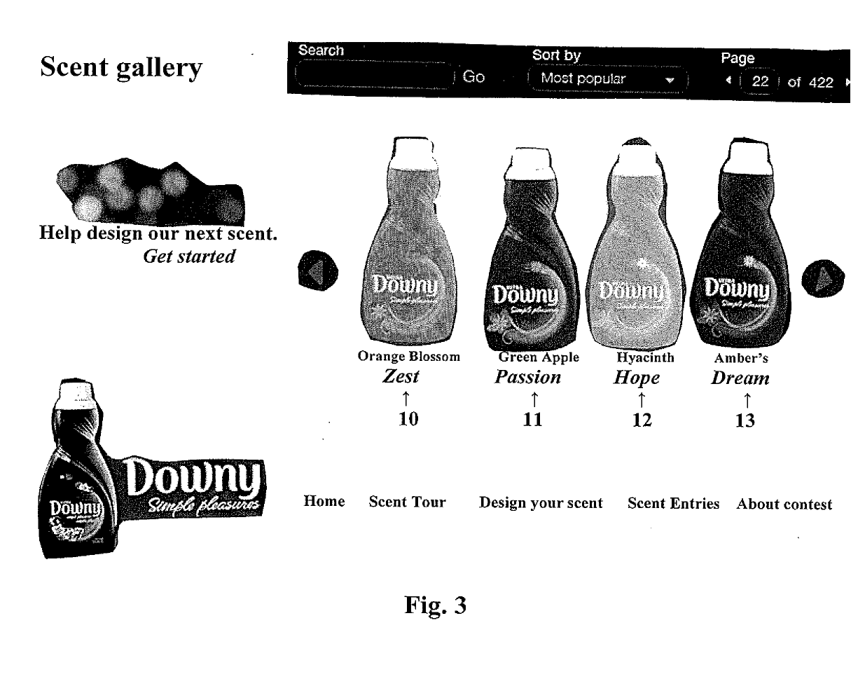

Another aspect of the invention provides using the statistically analyzed consumer scent naming data to generate a plurality of scent names voted upon by the consumer; providing an Internet Web page that invites the consumer to vote on a plurality scent names; and obtaining the consumer's response to voting on the scent names as voting emotion naming data. FIG. 3 is a Web page that provides four options of perfume scent names (and corresponding emotion names) for the consumer to vote upon. These options include: 1) perfume scent name “Orange Blossom” with corresponding emotion name “Zest” (10); 2) perfume scent name “Green Apple” with corresponding emotion name “Passion” (11); 3) perfume scent name “Hyacinth” with corresponding emotion name “Hope” (12); 4) perfume scent name “Amber's Dream” with corresponding emotion name “Dream” (13). The consumer simply selects the perfume scent name and the data is collected as voting emotion naming data. Data collection from the Internet (and storage thereof) is well known in the art. In one embodiment, the voting emotion naming data may be statistically analyzed. In another embodiment, the method comprises the step of designing the scent name of the consumer product by using the statistically analyzed voting emotion naming data. The term “statistically analyzed” is previously defined.

The results of the voting may be used to help design and manufacture the consumer product.

Although many of the embodiments of the present invention are described as a discrete pages, it is appreciated that the content of the pages may be combined or separated and still be within the scope and spirit of the invention. Of course the sequence of the pages may be altered or other pages not described herein can be inserted, with such embodiments still within the scope of the invention. In other words, the use of the terms “1^{st} page” and “2^{nd} page” are used for convenience only and not to suggest that the pages need to be displayed as separate pages.

Internet Web site hosting (including receiving consumer input from consumer's interaction with the Web site) is well known. A company that may provide such services includes Digitas (33 Arch Street—Boston, Mass. 02110).

### Systems

Another aspect of the invention provides for systems and computer program products. The systems of the present invention include at least one computer-readable medium used for storing computer instructions, data, program products, and the like. A general example of a computer is described in US 2006/0010027 A1, paragraph 78. Examples of computer readable media are compact discs, hard disks, floppy disks, tape, magneto-optical disks, PROMs (EPROM, EEPROM, Flash EPROM, etc.), DRAM, SRAM, SDRAM, etc. Stored on any one or on a combination of computer readable media, the present invention includes software for controlling both the hardware of computers. Such software may include, but is not limited to, device drivers, operating systems and user applications. Likewise, the apparatus can include input and output provisions to easily update the software controlling the hardware, the consumer interactive systems and enabling for the collection of consumer input data for further research.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of making a consumer product having a perfume scent name comprising the steps:
(a) optionally providing an Internet Web page that invites the consumer to participate in designing the scent name to the consumer product;
(b) providing an Internet Web page to the consumer that provides at least two categories of sub-scents, wherein each of the at least two categories has a plurality of sub-scent names selectable by the consumer;
(c) obtaining the consumer's selection to the plurality of sub-scents for each category to generate consumer sub-scent selection data;
(d) using the consumer sub-scent selection data to design the perfume scent name of the consumer product;
(e) manufacturing the consumer product having the designed perfume scent name.

2. The method of claim 1, wherein the scent is divided into at least three categories, and wherein the sub-scents contained in each category are unique to that category.

3. The method of claim 2, wherein the only a single sub-scent is selectable by the consumer for each category.

4. The method of claim 3, wherein each sub-scent name describes the scent of a perfume ingredient.

5. The method of claim 4, wherein each perfume ingredient comprises a boiling point, and wherein the perfume ingredients are organized within the at least three categories by the perfume ingredient's boiling point.

6. The method of claim 1, further comprising the steps of providing an Internet Web page that invites the consumer to provide the scent name to the consumer product; and obtaining the consumer's response to naming of the scent as consumer scent naming data.

7. The method of claim 6, further comprising the steps of providing an Internet Web page that invites the consumer to name an emotion to the scent name the consumer provides; and obtaining the consumer's response to naming of the emotion as consumer emotion naming data.

8. The method of claim 6, further comprising the step statistically analyzing the consumer scent naming data.

9. The method of claim 7, further comprising the step of statistically analyzing the consumer emotion naming data.

10. The method of claim 1, further comprising the step of statistically analyzing the consumer sub-scent selection data.

11. The method of claim 8, further comprising the steps: using the statistically analyzed consumer scent naming data to generate a plurality of scent names voted upon by the consumer; providing an Internet Web page that invites the consumer to vote on a plurality scent names; and obtaining the consumer's response to voting on the scent names as voting emotion naming data.

12. The method of claim 11, further comprising the step of statistically analyzing the voting emotion naming data.

13. The method of claim 12, further comprising the step of designing the scent name of the consumer product by using the statistically analyzed voting emotion naming data.

14. The method of claim 9, further comprising the steps:
(a) using the statistically analyzed consumer emotion naming data to generate a plurality of emotion names voted upon by the consumer;
(b) providing an Internet Web page that invites the consumer to vote on the generated plurality of emotion names;
(c) obtaining the consumer's vote on the generated plurality of emotion names as voting emotion names data;
(d) statistically analyzing the voting emotion names data; and
(e) designing the consumer product by using the statistically analyzed voting emotion names data;
(f) optionally naming the consumer product with the emotion name.

15. The method of claim 1, wherein the consumer product is a fabric care product.

16. The method of claim 15, wherein the fabric care product is a liquid, rinse-added, fabric softener product.
